(19) United States
(12) Patent Application Publication
(10) Pub. No.: US 2011/0270419 A1
(43) Pub. Date: Nov. 3, 2011

(54) METHOD AND SYSTEM FOR CONTROLLING THE WORKING STATUS OF AN ELECTRIC DEVICE

(75) Inventors: Wan Kei Ha, Shanghai (CN); Xin Chen, Shanghai (CN)

(73) Assignee: KONINKLIJKE PHILIPS ELECTRONICS N.V., EINDHOVEN (NL)

(21) Appl. No.: 13/143,366

(22) PCT Filed: Jan. 11, 2010
(86) PCT No.: PCT/IB2010/050075

§ 371 Date: Jul. 6, 2011

(30) Foreign Application Priority Data
Jan. 13, 2009 (CN) 200910003114.0

(51) Int. Cl. G06F 17/00

(52) U.S. Cl. 700/12; 700/94

(57) ABSTRACT

The invention provides a method and a corresponding system (12, 32) for controlling the working status of a first device (10, 30). The first device is connected with a second device (11, 31). The method comprises: a first analyzing step (S20) for analyzing whether the second device is using the first data provided by the first device; a step (S21) for controlling, based on the result of the first analyzing step, the working status of the first device. According to embodiments of the present invention, the working status of the first device can be changed when the second device temporarily does not use the first data provided by the first device, thereby saving energy, economizing on hardware resources and so on.

### TECHNICAL FIELD

The present invention relates to electric devices, especially to a method and a system for controlling the working status of electric devices.

### BACKGROUND OF THE INVENTION

Nowadays, more and more electric devices have become a part of people's daily lives and work. As a result, data exchanges between electric devices are very prevalent, e.g. a DVD player provides media data to a TV; a set-top-box (STB) provides information like media data, e-mails, images etc. to a TV; a scanner provides scanned data to a data base or a data analyzer.

### SUMMARY OF THE INVENTION

However, among electric devices exchanging data, it often occurs that a device provides a service to another device which does not use that service. This may result in a waste of hardware resources (e.g., memories, channels) and energy as well.

The present invention provides a technical solution for controlling the working status of a first device, wherein the first device is connected to a second device. The method comprises a first analyzing step, for analyzing whether the second device is using the first data being provided by the first device; and a controlling step, for controlling the working status of the first device according to the analysis result of the first analyzing step.

According to an embodiment of the invention, there is provided a method of controlling the working status of a first device, wherein, if the result of the first analyzing step shows that said second device is not using said first data, the controlling step comprises at least one of the following steps:
stopping step, for stopping the first device from providing said first data to said second device;
generating step, for generating information which indicates that the second device is not using said first data.

According to another embodiment of the invention, there is provided a system for controlling the working status of a first device, wherein the first device is connected to a second device, the system comprising: a first element, configured to analyze whether the second device is using the first data being provided by the first device; a second element, configured to control the working status of the first device according to the analysis result obtained by the first element. In this connection, the second element comprises at least one of the following units: a third unit, configured to stop the first device from providing said first data to said second device, if the analysis result obtained by the first element indicates that the second device is not using the first data; a fourth unit, configured to generate information which indicates that said second device is not using said first data.

According to a preferred embodiment of the invention, after having stopped providing the first data, the first device can resume the action of providing the first data to the second device when the second device needs to use the first data.

According to the embodiments of the present invention, the working status of the first device can be changed when the second device is temporarily not using the first data provided by the first device, e.g. it can stop providing said first data, so as to economize on hardware resources and save energy.

### BRIEF DESCRIPTION OF THE DRAWINGS

Other features and advantages of the present invention will appear in the following description of non-limiting exemplary embodiments, with reference to the appended drawings. In the drawings, similar or same reference signs represent similar or same technical features.

FIG. 1 illustrates a system for controlling the working status of a first device and the corresponding first and second devices, according to an embodiment of the invention;

FIG. 2a shows a flowchart of the method of controlling the working status of a first device according to an embodiment of the invention;

FIG. 2b shows a flowchart of the method of controlling the working status of a first device according to another embodiment of the invention;

FIG. 2c shows the internal flow of step S20 shown in FIG. 2a according to an embodiment of the invention;

FIG. 3 illustrates the system for controlling the working status of a first device and the corresponding first and second devices, according to an embodiment of the invention;

FIG. 4a shows the block diagram of a system for controlling the working status of a first device according to the first embodiment of the invention;

FIG. 4b shows the block diagram of a system for controlling the working status of a first device according to the second embodiment.

### DETAILED DESCRIPTION OF EMBODIMENTS

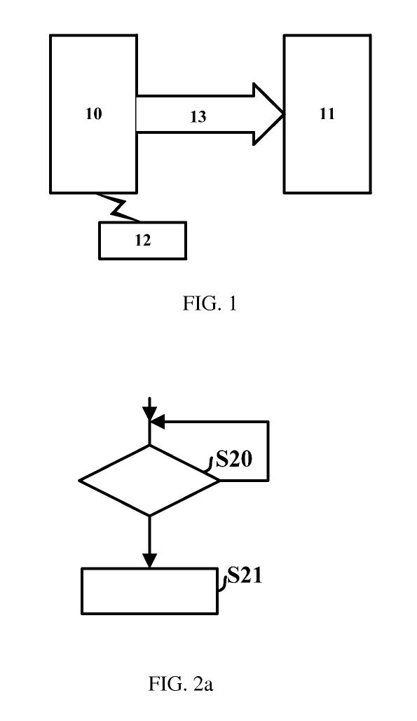

FIG. 1 illustrates a system for controlling the working status of a first device and the corresponding first and second devices, according to an embodiment of the invention. In said Figure, the first device 10 is connected to the second device 11 via a wired or wireless link and provides the first data 13 to the same. The system 12 is integrated into the first device or communicates with the first device 10 via a wired or wireless link so as to control the working status thereof. It should be understood that, although a one-way arrow is used in FIG. 1 to represent the exchange between the first and the second device, this does not restrict the protective scope of the present invention. According to an embodiment of the present invention, the second device 11 can also transmit information to the first device 10.

Besides, it should be understood that a first device mentioned in this text can be any kind of electric device for providing data to another device, e.g. a STB, a DVD player, a CD player, a radio, a scanner, a computer, etc. A second device is not restricted to the above-mentioned TV, it can also be an electric device which can be used to receive data from another device, such as a loudspeaker, a display, a data processing/storing device etc.

Accordingly, the first data can be data in any form, e.g. AV (Audio Video) content including audio/video information provided by a STB to a TV, pure audio content, pure video content, e-mails, images, or audio and/or video content provided by a DVD player to a TV, or data outputted by a computer to a display or a loudspeaker, scanned data provided by a scanner to a data processing/storing device, etc. The same applies for the second data.

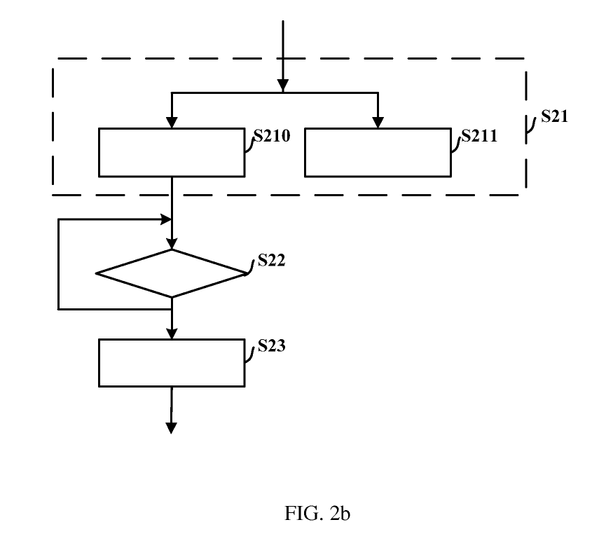

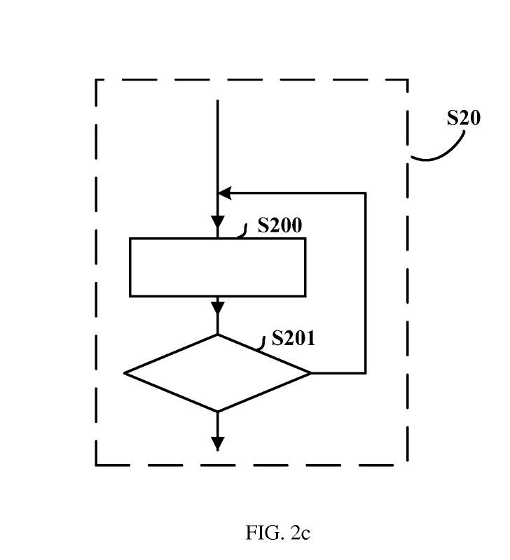

FIG. 2a shows the flowchart of the method of controlling the working status of a first device according to an embodiment of the invention. In said embodiment, the first device 10 provides the first data 13 to the second device 11. The method comprises: a first analyzing step S20 for analyzing whether the second device 11 is using the first data 13 being provided by the first device 10; a controlling step S21, in which the system 12 controls the working status of the first device 10 based on the result of the first analyzing step.

### The First Embodiment

In the first embodiment of the invention, without loss of generality, use is made of a scanner as an example of the first device 10, which will be referred to as the scanner 10 in this embodiment; and use is made of a data analyzing device like a computer as an example of the second device 11, which will be referred to as the computer 11 in this embodiment. The system 12 is integrated into the scanner 10. The scanner 10 is scanning a certain scanning object, such as an image, a text or parameters of body signs, and providing the scanned data, that is the first data 13, to the second device, that is the computer 11. In this embodiment, the first data 13 provided by the scanner 10 is referred to as the scanned data 13.

In this embodiment, the first analyzing step S20 is implemented in this manner:

The computer 11 can ascertain whether it is using the scanned data 13 provided by the scanner 10, and report periodically to the system 12 integrated inside the scanner 10.

Based on the report from the computer 11, the system 12 can get the analysis result of the first analyzing step S20.

After the first analyzing step S20, the subsequent process of the method in different circumstances will be described hereinbelow with reference to the detailed flow shown in FIG. 2b.

The First of the different circumstances referred to above:

The computer 11 is not using the scanned data 13 provided by the scanner 10. As regards this circumstance, the computer 11 probably receives an instruction from an outside source instructing it to stop performing storing, calculating processes etc. on all scanned data; or to stop processing the scanned data 13 from the scanner 10; or to shut down the computer 11. Or, according to rules of internal programs, the computer 11 needs to stop processing the scanned data 13 from the scanner 10. Therefore, the computer 11 reports to the system 12 that it is not using the scanned data 13 provided by the scanner 10.

Then, the system 12 executes at least one of the stopping step S210 and the generating step S211. The stopping step S210 is for stopping the scanner 10 from providing the scanned data 13 to the computer 11, while the generating step S211 is for generating information indicating that the computer 11 is not using the scanned data 13.

In case the scanner 10 is providing the scanned data 13 to a plurality of computers including the computer 11, the stopping step S210 can be realized in such a way that the scanner 10 closes the port connected to the computer 11, so that unnecessary power consumption can be reduced without affecting the storing and calculating process on other computers which need the scanned data 13.

Optionally, especially when only the computer 11 is being provided with the scanned data 13 by the scanner 10, the stopping step S210 further comprises a step in which: the system 12 shuts down the scanner 10 or controls the scanner 10 so as to enter the stand-by state (this step is not shown in the Figures for conciseness). This results in a greater reduction of the power consumption than by just stopping to provide the scanned data 13.

During the period of time that the computer 11 does not use the scanned data 13 provided by the scanner 10, if the scanner 10 does not stop scanning the object, there will be more scanned data generated. If the scanned data is not stored, the scanner 10 will have to rescan the object(s) which has(have) already been scanned when the computer 11 needs the scanned data 13 again; this is time-consuming and uneconomical. Therefore, after the scanner has stopped providing the scanned data 13 to the computer 11, if the scanner 10 is still performing the scanning operation, preferably, the controlling step S21 further comprises: storing the scanned data 13 subsequently obtained by the scanner 10 in a memory inside or outside the scanner 10. For conciseness, the storing step is not shown in FIG. 2b.

In this embodiment, the information, generated in the generating step S211, for indicating that the computer 11 is not using the scanned data 13 is multi-purpose. For example, it can be simply stored as the log of the scanner 10 and/or the computer 11, or provided to the user of the scanner 10 via the human-computer interaction interface in a visible or audible way, or provided to the user of the computer 11 via the human-computer interaction devices of the computer 11 such as a display, a loudspeaker, etc.

After the stopping step S210, as shown in FIG. 2b, the method further comprises a second analyzing step S22, for analyzing whether the computer 11 needs to use the scanned data 13, and a resuming step S23, for making the scanner 10 resume providing the scanned data 13 to the computer 11, when the result of the second analyzing step S22 indicates that the computer 11 needs to use the scanned data 13.

Since the computer 11 in this embodiment is capable of identifying and reporting whether it needs to use the scanned data 13, the system 12 can rely on the report from the computer 11 to fulfill the second analyzing step S22.

When the report from the computer 11 shows that the computer 11 needs to use the scanned data 13, the method enters step S23. In this step, the system 12 controls the scanner 10 so as to resume providing the scanned data 13 to the computer 11.

The second of the different circumstances:

The first circumstance in the first embodiment mainly focuses on the case in which the result of the first analyzing step S20 indicates that the computer 11 is not using the scanned data 13 provided by the scanner 10. In the second circumstance in the first embodiment, however, the computer 11 is using the scanned data 13 being provided by the scanner 10 for storing, comparison etc. Thus, the computer 11 can report to the system 12 that it is using the scanned data 13. Alternatively, the computer 11 does not report, implying that it is using the scanned data 13. This depends on the agreement between the computer 11 and the system. The agreement can be realized by presetting.

In this circumstance, the scanner 10 will keep providing the scanned data 13 to the computer 11.

### The Second Embodiment

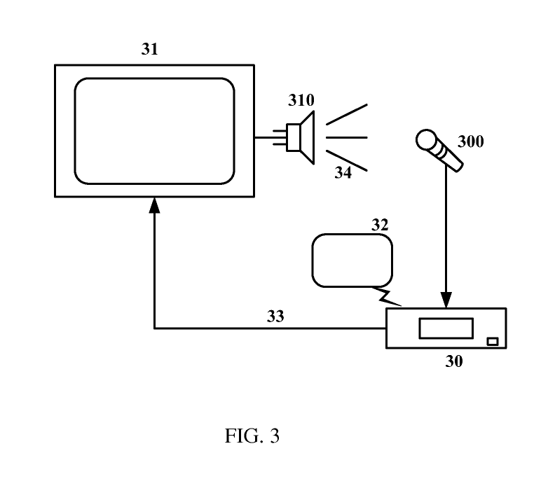

The second embodiment of the present invention will be described with reference to FIG. 3 and in conjunction with FIGS. 2a-2c. In FIG. 3, the first device is an STB 30, the second device is a TV 31. The STB 30 is connected with the TV 31 via audio/video data cable. The STB 30 is, for example, used to provide data from a dedicated server to the TV. The system 32 is integrated into the STB 30, or is separate from the STB 30 and can control the latter in a wired or wireless way. In this embodiment, without loss of generality, the system 32 is integrated into the STB 30 by way of example.

At a certain moment in time, the STB 30 provides the first data 33 to the TV 31. The first data 33 is, for example, AV (Audio and Video) content, images, characters, audible data etc, which are sent by a family member away from home to the aforesaid dedicated server through using his/her cell phone and then forwarded by the server to the STB 30. Hereinbelow, without loss of generality, the AV content including audio and video data is taken as an example, and referred to as AV content 33.

The first analyzing step S20 consists in that the system 32 analyzes whether the TV 31 is playing the AV content 33 provided by the STB 30. The detailed internal flow is shown in FIG. 2c.

The first analyzing step S20 comprises steps such as those given below:

A collecting step S200: the system 32 collects the audio signal 34 outputted by the TV 31.

A comparing step S201: the system 32 compares the collected audio signal 34 with the audio signal in the AV content 33 provided by the STB 30, so as to analyze whether the TV 31 is playing the AV content 33.

Optionally, the collecting step S200 can be realized by a microphone 300. In this embodiment, the microphone 300 is integrated into the STB 30 together with the system 32.

Then, the method enters the comparing step S201. The system 32 then compares the audio signal 34 with the audio signal in the AV content 33 provided by the STB 30. To increase the reliability of the comparison result, the collected audio signal 34 can be filtered first, e.g. for anti-aliasing, to get rid of the part with higher frequency thereof, so that aliasing during sampling can be avoided.

The signal after filtering will further be sampled and quantified, i.e. analog-digital conversion, whereupon a digitized audio signal is obtained.

Since the sampling and quantization performed on the analog signal may introduce noise, preferably, after obtaining said digitized audio signal, another filtering process can be performed thereon, so as to eliminate (or at least minimize) noise. Besides, said noise is not limited to the noise introduced during the sampling and quantization process, it can also include environmental noise collected by the microphone 300.

Besides, when the user is enjoying the AV content played by the TV 31, it is possible that he/she will turn up or turn down the output volume of the TV 31 according to his/her personal favor. This results in a difference in amplitude between the collected audio signal 34 and the original audio signal in the AV content 33.

Therefore, before the above-mentioned comparison, preferably, the amplitude of the aforesaid collected and finally digitized audio signal will be adjusted, so that it can match the original audio signal in amplitude, so as to facilitate the later comparison.

Preferably, the comparing step S201 takes the propagation time of sound waves in the air into consideration. Therefore the audio signal in the AV content 33 provided at T₀ by the STB 30 will not be collected by the microphone 300 until (T₀+T), while T is approximately the time the sound wave takes to travel to the microphone 300 from the loud speaker 310 of the TV 31.

There are many ways of comparing the digitized audio signal 34 with the original audio signal, one of which is to calculate the cross-correlation, wherein fⱼ stands for the digitized audio signal 34, while gᵢ stands for the original audio signal (after digitizing) in the AV content 33. The cross-correlation function is given by the expression (1) below:

$${( f * g )}_{i} ≡ {\sum }_{j} {f}_{j}^{*} {g}_{i + j} \qquad ( 1 )$$

Therefore, with i as the variable, by multiplying this cross-correlation function point by point within an interval, and comparing the obtained value with a preset threshold, the correlation between the collected audio signal 34 and the original audio signal can be judged, so that it can be analyzed whether the TV 31 is playing the AV content 33 provided by the STB 30.

Those skilled in this art should understand that calculating by means of the cross-correlation function is not the only way of doing this comparison. For example, it can also be realized by using the Minimum Mean Squared Error, as shown in expression (2):

$${\sum }_{i = 1}^{N} \vert \frac{{( {f}_{i} - {g}_{i} )}^{2}}{{σ}^{2 }} \vert \leq τ \qquad ( 2 )$$

In said expression, σ² and τ are parameters preset in STB 30. It can be analyzed whether the TV 31 is playing the AV content 33 provided by the STB 30 by just calculating at N sampling points, and comparing the sum with τ on the right side.

So far, the analysis result of the first analyzing step S20 has been obtained.

If the TV 31 is still playing the AV content 33 provided by the STB 30, it is unnecessary to adjust the working status of the STB 30. The system 32 can execute the first analyzing step S20 again without delay, or after a predefined time duration has elapsed (e.g. several seconds to tens of seconds). No more unnecessary details will be given herein.

Referring to FIG. 2b, if TV 31 is not playing the AV content 33 provided by the STB 30, at least one of said stopping step S210 and said generating step S211 will be executed.

It should be understood that, if TV 31 is not playing the AV content 33, which AV content 33 comprises audio data and video data, in the stopping step S210, the system 32 can control the STB 30 so as to stop providing the audio data or video data, or both.

In the generating step S211, the STB 30 generates information indicating the TV 31 is not playing the AV content 33. The information can be used to prompt the user enjoying the TV program to shut down the STB 30 by means of a remote controller etc.; the information can also be reported to the provider of the AV content 33 for statistical purposes.

It should be understood that the stopping step S210 can be carried out in various ways, such as by stopping to provide the AV content 33 to the TV 31, which is similar to the case that the user presses the ‘STOP’ key on the remote controller of the STB 30; powering off the STB 30; or switching the STB 30 to the standby status. In addition, either powering off or switching it to standby helps save energy.

Optionally, after the stopping step S210, the controlling step S21 further comprises a storing step (not shown in the Figures), the storing step being mainly applicable in the circumstances that the first data is broadcasting data or flow data of a media website. In that case, the system 32 itself stores the AV content 33, or controls the STB 30 to do the storing process. This is because, in many circumstances, especially when the first data provided by the STB 30 to the TV 31 is not stored locally in the STB 30 but originates from a third party and is simply forwarded by the STB 30, it is possible that the STB 30 does not backup the first data provided to the TV 31. Here, the provider of the AV content 33 sends the captured AV content 33 to the STB 30 through a server in real time, the STB 30 stops providing the AV content 33 to the TV 31, and, preferably, the STB 30 stores the AV content 33 within the time interval that the providing of the AV content 33 is stopped. Automatic playback of the stored data can be performed when the user switches the TV 31 back to the channel served by the STB 30. Alternatively, the user can be prompted via a man-machine interface, and playback is done based on the instruction input by the user.

After the STB 30 has stopped providing the AV content 33 to the TV 31, preferably, as shown in FIG. 2b, the method further comprises steps as given below: a second analyzing step S22, for analyzing whether the TV 31 needs to use the first data, i.e. the AV content 33; and a resuming step S23 which is used, if the result of the second analyzing step is that the TV 31 needs to use the AV content 33, for making the first device, i.e. the STB 30, resume the action of providing the AV content 33 to the TV 31.

In this embodiment, preferably, the result of the second analyzing step S22 for analyzing whether the TV 31 needs to use (play) the AV content 33 provided by the STB 30 can be obtained by collecting the audio signal outputted by the TV 31 and performing a further comparison.

Said second analyzing step S22 further comprises a sub-step (not shown in the Figures) of providing second data to said second device. This concretely means that the system 32 gives indicating information to the STB 30. Based on this information, the STB 30 then provides the second data to the second device, i.e. the TV 31. In this embodiment, the second data comprises audio data. Accordingly, in the second analyzing step S22, it is analyzed whether the TV 31 is using (playing) the second data. If the TV 31 is using the second data, the method enters step S23, in which the STB 30 is made to resume providing the AV content 33 to the TV 31.

The second data can be audio data dedicated to the analysis and has nothing to do with the AV content 33; or audio data in the AV content 33. For example, in the stopping step S201, the STB 30 only stops providing the video data of the AV content 33, and goes on providing the audio data therein as the second data.

By providing the second data, it can be guaranteed that the second data can be received by the TV 31 immediately when it gets back to the channel served by the STB 30, and is subsequently played by the loudspeaker 310 and finally collected by the microphone 300, so as to execute the second analyzing step S22.

The second analyzing step S22 according to this embodiment comprises sub-steps in addition to the aforesaid one of providing the second data, said sub-steps including: collecting the audio signal (not shown in the Figures) outputted by the second device, i.e. the TV 31; comparing the audio signal outputted by the TV 31 with the audio signal of the second data provided by the first device, i.e. the STB 30, so as to analyze whether the TV 31 is using (playing) the second data (not shown in the Figures).

Since the collecting step in the second analyzing step S22 is substantially the same as the aforementioned one S200, and the comparing step in the second analyzing step S22 is substantially the same as the aforementioned one S201, no more unnecessary details will be given in this regard.

In the above paragraphs, embodiments in which digitized audio signals are compared directly in the first and second analyzing steps are described. Hereafter, an embodiment in which audio finger prints are compared in the first and second analyzing steps will be depicted. Since the first and second analyzing steps share the same principle, only the first analyzing step is taken as an example hereinafter.

It should be understood that the present invention uses audio finger prints as an instance to explain the principles; it is not excluded that other kinds of finger prints such as video finger prints can be used to compare and match two data portions.

Finger prints refer to a brief abstract of audio or video content (also called robust hash) obtained from related aspects of audio or video content which can be perceived. Finger prints can be obtained, for example, by performing a hash transformation on the audio or video content. Therefore, audio or video finger prints map audio or video data comprising a large number of bits to finger prints with a very limited number of bits. In other words, the finger prints of audio or video data can represent the audio or video data. Audio finger prints can represent audio content; video finger prints can represent video content. If there are two audio or video content pieces in a different format but with the same content, the finger prints of one of them will match the other. There are lots of ways of obtaining and comparing audio finger prints; therefore, no more unnecessary details will be given in this regard.

It should be understood that any first/second data, the finger prints of which can be obtained by the first device or the system provided by the present invention, can be used to realize the aforesaid comparison based on audio finger prints. In this case, the most typical first data satisfying this condition is in the form of slides with background music. According to an embodiment of the invention, broadcasting data carries finger print information when received by the STB 30, the system 32 can control the STB 30 to get it stored for comparison. Preferably, the finger print information is formed by the basic audio finger prints of the corresponding broadcasting content.

Thus, in the first analyzing step S20, first of all, the character of the first or second data provided by the STB 30 to the TV 31 is identified. If the comparison can be performed by using audio finger prints, audio finger prints will be chosen as the objects to be compared. Otherwise, the audio signal itself will be compared in analog domain or digital domain.

After that, the system 32, or the STB 30 under the control of the system 32, will use the audio signal collected by the microphone 300 to generate the finger prints of the collected audio signal. The interval for collecting the audio finger prints is several seconds to tens of seconds.

Then, the generated finger prints will be compared with the pre-stored finger prints. When the similarity between the audio finger prints of the collected audio signal and the pre-stored audio finger prints satisfies a predefined condition, it can be established that the TV 31 is playing the first or second data provided by the STB 30.

The description given with respect to the second embodiment mainly talks about solutions in which audio signals are compared in digital domain. According to a variation of the second embodiment, analog audio signals can be processed and compared directly in the first and second analyzing steps.

In the second embodiment and the aforesaid variations thereof, judgments are based on audio signals; this is because the channels between an existing STB, DVD etc. and a TV are unidirectional. That is to say, the TV cannot provide feedback information to the STB, DVD. Hence, the STB cannot know whether the TV is playing the media content provided by it according to the active feedback. Those skilled in the art should understand, according to the teachings of the present invention, that they can definitely realize the idea of the invention in the scenarios given hereinbelow, and all of the realizations fall within the protective scope that is limited only by the appended claims of the invention. The circumstances are as follows:

In one of the scenarios, there is a feedback channel between the TV and the STB, which is wired or wireless. In that feedback channel, the TV can report to the STB directly that: “I have been switched to another channel from the one served by you”. Therefore, based on the report, the STB can be controlled so as to execute at least one of the aforesaid stopping step S210 and generating step S211.

Those skilled in the art will understand that integrating the microphone in the STB, i.e. the first device, is not the only way of realizing the present invention. For example, the microphone can also be set on a remote controller which is just opposite the TV in general.

In the paragraphs above, the method of controlling the working status of a first device according to embodiments of the invention is described with reference to the appended drawings. Hereinafter, the system corresponding with the method will be depicted, wherein, since the functions of the elements and units in the system have already been described in detail in the form of steps, the description will be concise. Those skilled in the art will understand that this will never affect the sufficient disclosure of the present invention by means of the specification.

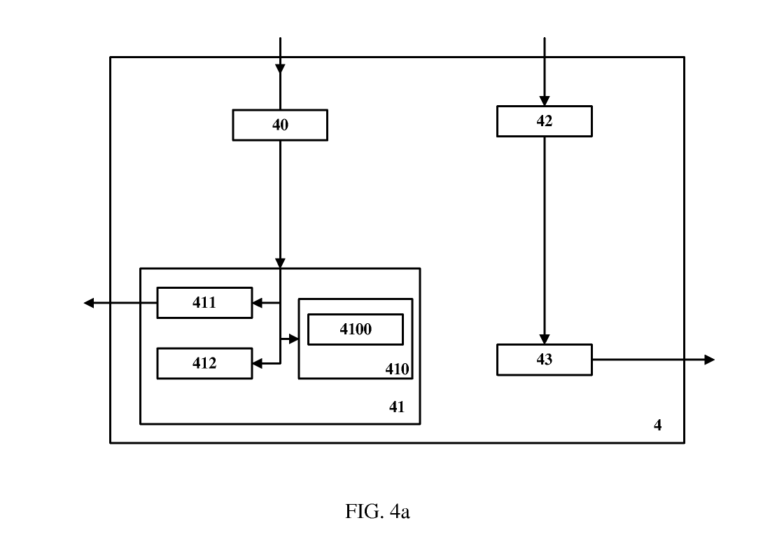

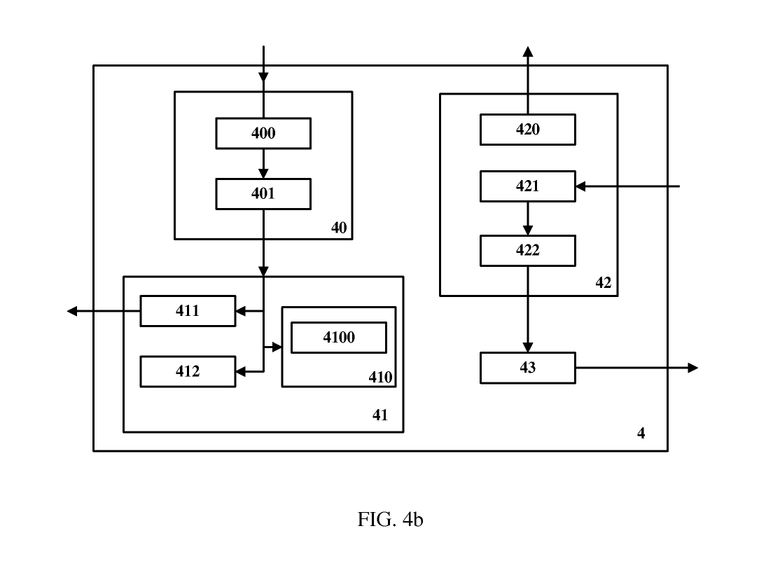

FIGS. 4a, 4b illustrate respectively the block diagrams of a system for controlling the working status of a first device according to the first and second embodiment of the invention. The system 4 comprises a first element 40, configured to analyze whether the second device is using the first data being provided by the first device, i.e. performing said first analyzing step S20; and a second element 41, configured to control the working status of the first device according to the analyzing result of the first element 40, i.e. performing said controlling step S21.

Preferably, as shown in FIG. 4b, the first element 40 further comprises: a first unit 400, configured to execute said collecting step S200 in case the first data comprises audio signals (e.g. the AV content 33 in the second embodiment); and a second unit 401, configured to execute said comparing step S201.

The second element 41 comprises at least one of the third unit 410 and the fourth unit 411. The third unit 410 is configured to execute said stopping step S210, and the fourth unit 411 is configured to execute said generating step S211.

In this case, the third unit 410 can make the first device stop providing the first data to the second device, or power off the first device by means of the first module 4100 therein.

Preferably, the second element 41 further comprises a fifth unit 412, configured to execute said storing step in case the third unit makes the first device stop providing the first data to the second device.

Preferably, the system 4 further comprises a third element 42, configured to analyze whether the second device needs to use the first data, i.e. configured to execute said second analyzing step S22, in case the third unit 410 controls the first device so as to stop providing the first data to the second device; and a fourth element 43, configured to make the first device resume providing the first data to the second device, i.e. configured to execute said step S23, when the result obtained by the third element 42 suggests that the second device needs to use the first data.

Preferably, the third element further comprises a sixth unit 420, configured to execute said step of providing the second data.

Furthermore, the third element further comprises a seventh unit 421, configured to compare the audio signal outputted by the second device with the audio signal in the second data provided by the first device, so as to analyze whether the second device is using the second data, i.e. configured to execute the comparing step in said second analyzing step.

Moreover, the third element further comprises an eighth unit 422, configured to make the first device resume providing the first data to the second device, i.e. configured to execute said continuing step, in case the analysis result obtained by the fourth element 43 is that the second device is using the second data, i.e. the second device needs to use the first data,

Since the functions of the seventh unit 421 and the first unit 400 are substantially the same, the functions of the eighth unit 422 and the second unit 401 are substantially the same, those skilled in the art will understand that, when implementing the present invention in practice, the seventh unit 421 and the first unit 400 can be realized by the same unit, similarly, the eighth unit 422 and the second 401 can also be realized by the same unit.

Since the description given with respect to the method has explained the functions of the aforesaid elements, units and modules as well as the steps executed by these elements, units and modules, no unnecessary details will be given here.

Those skilled in the art will understand any one of the first to the fourth element, the first to the eighth unit, and the first module can be realized by means of software, hardware or a combination thereof, e.g. a processor and the codes/instructions stored in the memory or hard disk. All these realization modes fall within the protective scope that is limited only by the appended claims of the present invention.

It should be understood that a same processor can be used to realize the aforesaid elements, units, modules when it works with different instructions/codes, and, multiple microprocessors can work together to realize an element or a unit or a module.

Although the embodiments of the present invention have been described above, it should be understood by those skilled in the art that various modifications can be made without departing from the scope and spirit of the appended claims.

What is claimed is:

1. A method of controlling the working status of a first device, wherein, the first device (10, 30) is connected with a second device (11, 31), the method comprising:
a first analyzing step (S20), for analyzing whether the second device is using the first data (13,33) provided by the second device;
a controlling step (S21), for controlling the working status of the first device based on the result of the first analyzing step.

2. The method according to claim 1, wherein, said first data comprises audio data, and said first analyzing step comprises the steps of:
collecting (S200) the audio signal outputted by the second device;
comparing (S201) the audio signal outputted by the second device with the audio data comprised in the first data, so as to analyze whether said second device is using said first data.

3. The method according to claim 1, wherein, if the result of the first analyzing step suggests that said second device is not using the first data, the controlling step comprises at least one of the following steps:
stopping (S210) the first device from providing said first data to the second device; or
generating (S211) information indicating that the second device is not using the first data.

4. The method according to claim 3, wherein, said stopping step (S210) further comprises a step of powering off said first device.

5. The method according to claim 3, wherein, when the controlling step comprises said stopping step, the controlling step further comprises a step of storing said first data.

6. The method according to claim 3, wherein, when the controlling step comprises said stopping step, the method further comprises:
a second analyzing step (S22), for analyzing whether the second device needs to use said first data; and
if the result of the second analyzing step is that the second device needs to use the first data, making (S23) the first device resume the action of providing the first data to the second device.

7. The method according to claim 6, wherein, the second analyzing step comprises:
a step in which the first device provides second data to the second device, said second data comprising audio data;
a step of collecting the audio signal outputted by the second device;
a step of comparing the audio signal outputted by the second device with the audio signal in the second data provided by the first device, so as to analyze whether the second device is using the second data.

8. A system (12, 32, 4) for controlling the working status of a first device, wherein, the first device (10, 30) is connected with a second device (11,31), the system comprising:
a first element (40), configured to analyze whether the second device is using the first data (13,33) provided by the second device;
a second element (41), configured to control the working status of the first device based on the result of the first analyzing step.

9. The system according to claim 8, wherein, said first data comprises audio data, said first element (40) comprising:
a first unit (400), configured to collect the audio signal outputted by the second device;
a second unit (401), configured to compare (S201) the audio signal outputted by the second device with the audio data comprised in the first data, so as to analyze whether said second device is using said first data.

10. The system according to claim 8, wherein, the second element (41) comprises at least one of the following units:
a third unit (410), configured to stop the first device from providing the second device with said first data if the result of the first analyzing step suggests that said second device is not using the first data being provided by the first device; or
a fourth unit (411), configured to generate information indicating that the second device is not using the first data if the result of the first analyzing step suggests that said second device is not using the first data being provided by the first device.

11. The system according to claim 10, wherein, said third unit further comprises a first module (4100), configured to power off said first device.

12. The system according to claim 10, wherein, the second element further comprises a fifth unit (412), configured to store said first data.

13. The system according to claim 10, further comprising:
a third element (42), configured to analyze whether the second device needs to use said first data if the first device stops providing the first data to the second device;
a fourth element (43), configured to make the first device resume providing the first data to the second device if the result of the third element is that the second device needs to use the first data.

14. The system according to claim 13, wherein the third element comprises:
a sixth unit (420), configured to make the first device provide second data to the second device, said second data comprising audio data;
a seventh unit (421), configured to collect audio signals outputted by the second device;
an eighth unit (422), configured to compare the audio signal outputted by the second device with the audio signal in the second data provided by the first device, so as to analyze whether the second device is using the second data.

15. The system according to claim 14, wherein, the second data is the audio data in the first data.
